(19) United States
(12) Patent Application Publication
(10) Pub. No.: US 2025/0360759 A1
(43) Pub. Date: Nov. 27, 2025

(54) PNEUMATIC TIRE

(71) Applicant: Sumitomo Rubber Industries, Ltd., Hyogo (JP)

(72) Inventor: Naoya SUZUKI, Kobe-shi (JP)

(73) Assignee: Sumitomo Rubber Industries, Ltd., Hyogo (JP)

(21) Appl. No.: 19/213,207

(22) Filed: May 20, 2025

(30) Foreign Application Priority Data
May 21, 2024 (JP) 2024-082817

(51) Int. Cl. B60C 13/02

(52) U.S. Cl. CPC B60C 13/02

(57) ABSTRACT

Provided is a pneumatic tire 1 having a side block 10 formed at a first sidewall portion 3A. An outer end 10e of the side block 10 is disposed in a region A1 extending over 30 mm in the tire radial direction around a point of intersection K1. The side block 10 includes a pair of first portions 11 each protruding over a first protrusion height H1 and a second portion 12 that is disposed between the first portions 11 and protrudes over a second protrusion height H2. The second portion 12 includes a second top surface 28. The first portion 11 includes a first top surface 21, an outer wall surface 22, and an inner wall surface 23. At a block outer position Be and a block inner position Bi, a sum of lengths La, Lb of the first top surfaces 21 and a length Lc of the second top surface 28 is 20% or more and 75% or less of a length LA of the side block 10 in the tire circumferential direction.

### BACKGROUND OF THE INVENTION

### Field of the Invention

The present disclosure relates to a pneumatic tire.

### Background Art

Japanese Laid-Open Patent Publication No. 2023-054637 discloses a pneumatic tire including a first buttress portion. The first buttress portion has a plurality of protectors protruding outward in the tire axial direction.

### SUMMARY OF THE INVENTION

In a pneumatic tire production method, it is known that an unvulcanized pneumatic tire is vulcanized and molded in a vulcanization mold. In the pneumatic tire having protectors as described above, there is room for examination for improving outer appearance of the first buttress portion since, for example, a lot of bareness is likely to occur in the first buttress portion due to air being not discharged during the vulcanization and molding.

The present disclosure has been made in view of the aforementioned circumstances, and a main object of the present disclosure is to provide a pneumatic tire that allows outer appearance of a first sidewall portion to be improved.

The present disclosure is directed to a pneumatic tire including: a tread portion; a first sidewall portion connected to the tread portion; and a belt layer embedded in the tread portion, the belt layer extending in a tire axial direction. At least one side block protruding outward from a sidewall reference surface in the tire axial direction is formed at the first sidewall portion. The side block includes an outer end in a tire radial direction. The outer end is disposed in a region extending over 30 mm in the tire radial direction around a point of intersection of an outer surface of the first sidewall portion, and an imaginary extension line obtained by extending the belt layer toward the first sidewall portion, on a tire meridional cross-section. The side block includes a pair of first portions protruding from the sidewall reference surface over a first protrusion height and extending in the tire radial direction, and a second portion protruding from the sidewall reference surface over a second protrusion height less than the first protrusion height, the second portion disposed between the pair of first portions. The second portion includes a second top surface parallel to the sidewall reference surface. Each of the pair of first portions includes a first top surface parallel to the sidewall reference surface, an outer wall surface connecting between the first top surface and the sidewall reference surface, and an inner wall surface connecting between the first top surface and the second top surface. At a block outer position distant from the outer end of the side block toward an inner side in the tire radial direction over 5 mm, and a block inner position distant from an inner end, in the tire radial direction, of the side block toward an outer side in the tire radial direction over 15 mm, a sum of lengths of a pair of the first top surfaces and a length of the second top surface is 20% or more and 75% or less of a length of the side block in a tire circumferential direction on the sidewall reference surface, on a cross-section obtained by cutting the side block in a direction normal to the sidewall reference surface along the tire circumferential direction.

The pneumatic tire of the present disclosure has the above-described configurations, and thus allows outer appearance of the first sidewall portion to be improved.

### BRIEF DESCRIPTION OF THE DRAWINGS

FIG. 1 is a tire meridional cross-sectional view of a pneumatic tire according to one embodiment of the present disclosure;

FIG. 2A is a front view of a side block;

FIG. 2B is a cross-sectional view taken along a line A-A in FIG. 2A;

FIG. 3 is an enlarged view of a first sidewall portion in FIG. 1;

FIG. 4 is an enlarged front view of the first sidewall portion;

FIG. 5 is a schematic diagram obtained by enlarging FIG. 4;

FIG. 6 is a perspective view of a cross-section of the side block;

FIG. 7A is a cross-sectional view taken along a line B-B in FIG. 5;

FIG. 7B is a cross-sectional view taken along a line C-C in FIG. 5; and

FIG. 7C is a cross-sectional view taken along a line D-D in FIG. 5.

### DETAILED DESCRIPTION

One embodiment of the present disclosure will be described below with reference to the drawings. The drawings include exaggerated expressions and dimensional ratios expressed so as to be different from those of the actual structure in order to aid in understanding of the present disclosure. In a case where a plurality of embodiments are described, the same or common components are denoted by the same reference characters throughout the description, and repeated description is omitted.

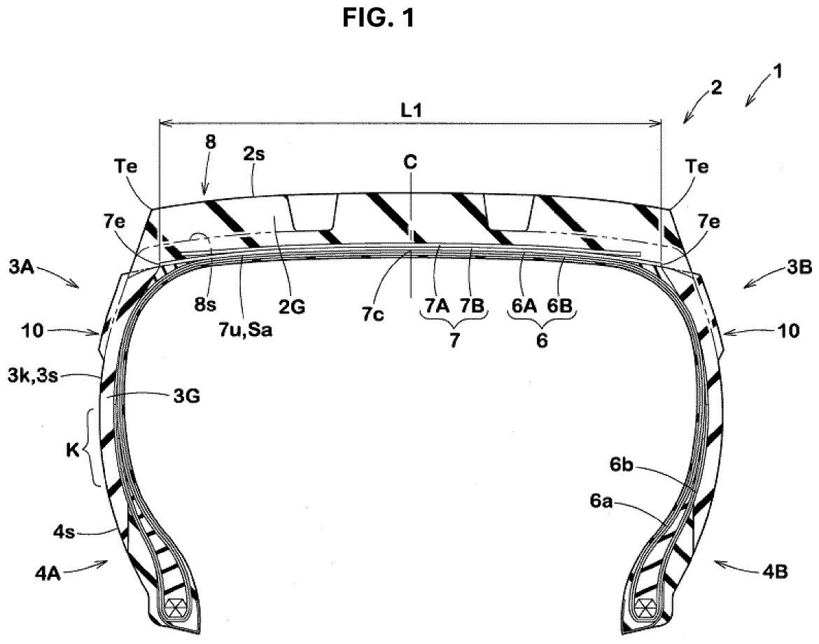

FIG. 1 is a tire meridional cross-sectional view of a pneumatic tire (hereinafter, may be referred to as “tire”) 1 according to one embodiment of the present disclosure, including a tire rotation axis (not shown). FIG. 1 shows a tire for a light truck as a preferable example. However, the present disclosure may be applied to a tire for a passenger car and a heavy duty tire. FIG. 1 shows the tire 1 in a standardized state.

The “standardized state” refers to a state in which a tire is mounted on a standardized rim and is adjusted to have a standardized internal pressure, and no load is applied to the tire, in the case of a pneumatic tire for which various standards are defined. For tires for which various standards are not defined, the standardized state refers to a standard use state, corresponding to a purpose of use of the tire, in which the tire is not mounted to a vehicle and no load is applied to the tire. In the description herein, unless otherwise specified, dimensions and the like of components of the tire are represented by values measured in the standardized state. Dimensions of components (for example, internal members of the tire 1) which cannot be measured in the standardized state are represented by values measured in a state where the tire 1 is approximated to the standardized state as much as possible.

The “standardized rim” refers to a rim that is defined, in a standard system including a standard on which the tire 1 is based, by the standard for each tire, and is, for example, “standard rim” in the JATMA standard, “Design Rim” in the TRA standard, or “Measuring Rim” in the ETRTO standard.

The “standardized internal pressure” refers to an air pressure that is defined, in a standard system including a standard on which the tire 1 is based, by the standard for each tire, and is “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

The tire 1 includes a tread portion 2, and a first sidewall portion 3A connected to the tread portion 2. The tire 1 also includes a belt layer 7 that is embedded in the tread portion 2 and extends in the tire axial direction.

The first sidewall portion 3A has at least one side block 10 protruding outward from a sidewall reference surface 3k in the tire axial direction. The side block 10 allows the first sidewall portion 3A to have a basic aesthetic shape (design).

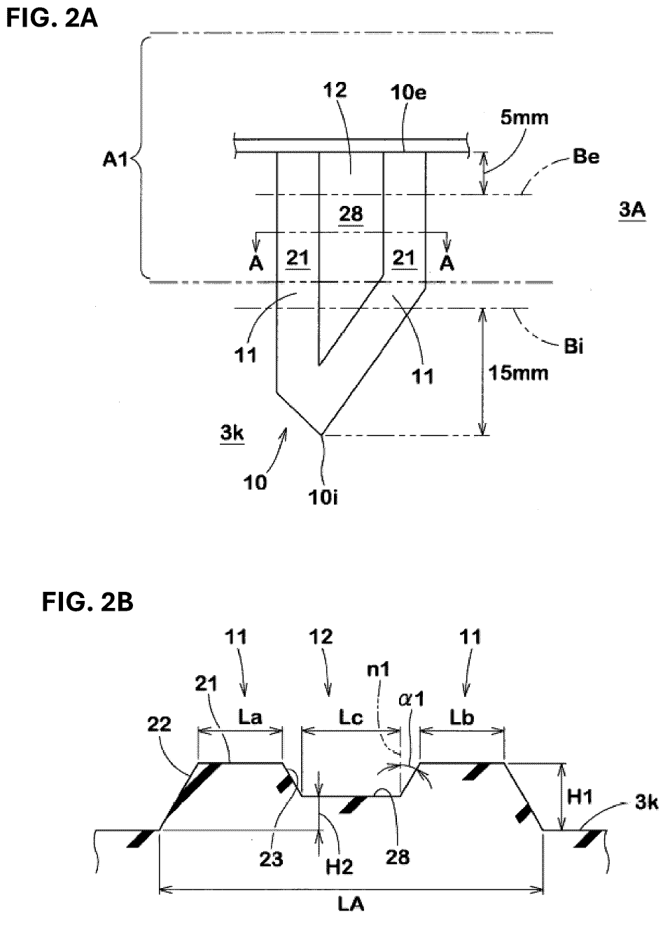

FIG. 2A is an enlarged front view of the first sidewall portion 3A. FIG. 2A shows one side block 10. As shown in FIG. 1 and FIG. 2A, the side block 10 includes an outer end 10e in the tire radial direction and an inner end 10i in the tire radial direction. The side block 10 also includes a pair of first portions 11, and a second portion 12 disposed between the pair of first portions 11.

FIG. 2B is a cross-sectional view taken along a line A-A in FIG. 2A. FIG. 2B shows a cross-section obtained by cutting the side block 10 in the direction normal to the sidewall reference surface 3k along the tire circumferential direction. As shown in FIGS. 2A and 2B, each of the first portions 11 protrudes from the sidewall reference surface 3k over a first protrusion height H1, and extends in the tire radial direction. The second portion 12 protrudes from the sidewall reference surface 3k over a second protrusion height H2 less than the first protrusion height H1. The second portion 12 includes a second top surface 28 that is parallel to the sidewall reference surface 3k. In the description herein, “parallel to the sidewall reference surface 3k” mainly means that an inevitable error in a rubber product such as a tire is allowable, and means that, for example, a state of being parallel to the sidewall reference surface 3k can be visually recognized. In a case where the first protrusion height H1 or the second protrusion height H2 varies in the tire radial direction, the first protrusion height H1 and the second protrusion height H2 are specified at the same position in the tire radial direction.

Each of the first portions 11 includes a first top surface 21 that is parallel to the sidewall reference surface 3k, an outer wall surface 22 connecting between the first top surface 21 and the sidewall reference surface 3k, and an inner wall surface 23 connecting between the first top surface 21 and the second top surface 28.

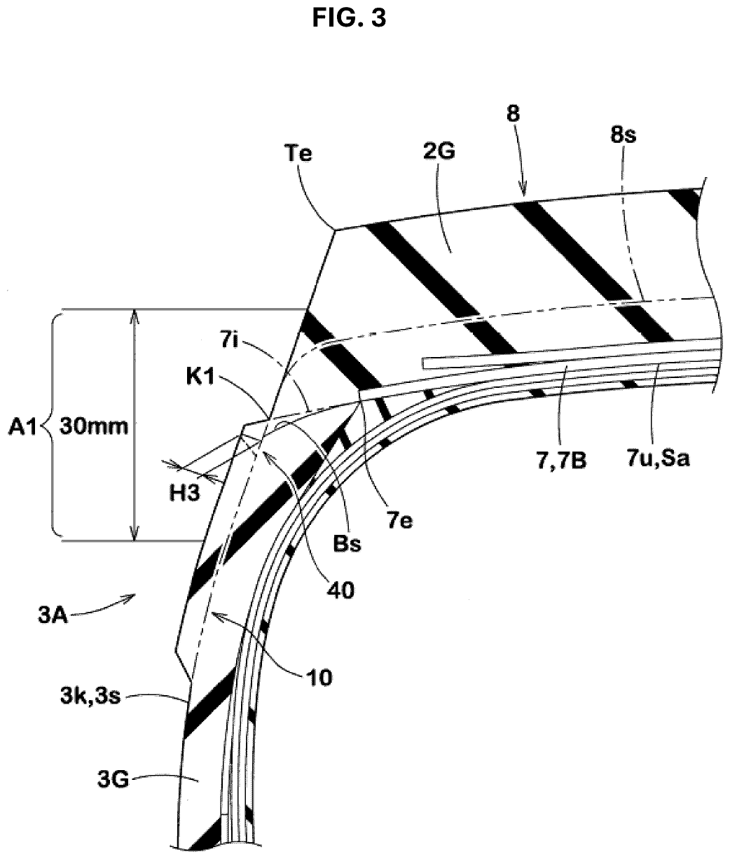

FIG. 3 is an enlarged view of the first sidewall portion 3A in FIG. 1. As shown in FIG. 1 to FIG. 3, on the tire meridional cross-section, the first sidewall portion 3A has a region A1 extending over 30 mm in the tire radial direction around a point of intersection K1. The point of intersection K1 is a point at which an imaginary extension line 7i obtained by extending the belt layer 7 toward the first sidewall portion 3A, and an outer surface 3s of the first sidewall portion 3A intersect each other. The region A1 is a portion at which a plurality of components of the tire 1 are stacked, and air of the components is likely to accumulate during vulcanization and molding (hereinafter, referred to as “during tire vulcanization”) of the tire 1. The components include the belt layer 7, sidewall rubber 3G and tread rubber 2G described below, and the like.

The outer end 10e is located in the region A1. Thus, during tire vulcanization, air in the components and air between the components can be accumulated in a vulcanization mold (not shown) for forming the side block 10, so that occurrence of bareness (portions at which bareness occurs) can be reduced. Furthermore, air is likely to accumulate in a vulcanization mold in contact with the first top surface 21 and the second top surface 28, and air is inhibited from flowing into another portion (for example, a vulcanization mold in contact with the sidewall reference surface 3k, etc.). Furthermore, the outer wall surface 22 and the inner wall surface 23 are portions at which contact pressure with respect to the vulcanization mold in contact with the outer wall surface 22 and the inner wall surface 23 becomes relatively low, during tire vulcanization, and air flow becomes smooth. Therefore, the side block 10 allows air to be efficiently accumulated during tire vulcanization, and allows, by discharging the air, outer appearance of the first sidewall portion 3A to be improved.

As shown in FIG. 2A, the side block 10 includes a block outer position Be and a block inner position Bi. The block outer position Be is distant from the outer end 10e of the side block 10 toward an inner side in the tire radial direction over 5 mm. The block inner position Bi is distant from the inner end 10i, in the tire radial direction, of the side block 10 toward an outer side in the tire radial direction over 15 mm. Air of the components is most likely to accumulate between the block outer position Be and the block inner position Bi during tire vulcanization. Furthermore, visibility from the outside of a vehicle at a portion between the positions Be and Bi is high in a state where the tire 1 is mounted to the vehicle, and influence on outer appearance of the first sidewall portion 3A is great at the portion.

As shown in FIG. 2B, a sum (La+Lb+Lc) of lengths La, Lb of the pair of the first top surfaces 21, and a length Lc of the second top surface 28 between the block outer position Be and the block inner position Bi is 20% or more and 75% or less of a length LA of the side block 10. In a case where the sum (La+Lb+Lc) is 70% or less of the length LA of the side block 10, flow of air to a vulcanization mold in contact with the first top surfaces 21 becomes smoother between the block outer position Be and the block inner position Bi during tire vulcanization. Thus, for example, air of the components is more easily accumulated into the vulcanization mold in contact with the first top surfaces 21. Furthermore, for example, air which is thus accumulated is efficiently discharged to the outside of the vulcanization mold through an air discharge hole (not shown) formed in the vulcanization mold. Furthermore, in a case where the sum (La+Lb+Lc) is 20% or more of the length LA of the side block 10, the side block 10 has an improved aesthetic shape (design). Therefore, the tire 1 of the present disclosure allows outer appearance of the first sidewall portion 3A to be improved. In the present embodiment, the sum (La+Lb+Lc) is 20% or more and 75% or less of the length LA of the side block 10 at any position between the block outer position Be and the block inner position Bi. The length LA of the side block 10 represents a length of the side block 10 in the tire circumferential direction on the sidewall reference surface 3k.

In order to more effectively exhibit the above-described effect, the sum (La+Lb+Lc) is preferably 35% or more and 50% or less of the length LA.

A difference (H1−H2) between the first protrusion height H1 and the second protrusion height H2 is preferably 0.5 to 5.0 mm. In a case where the difference (H1−H2) is 0.5 mm or more, flow of air is further improved during tire vulcanization, and portions at which bareness occurs can be further reduced. From such a viewpoint, the difference (H1−H2) is more preferably 1.0 mm or more and even more preferably 1.5 mm or more. In a case where the difference (H1−H2) is 5.0 mm or less, the side block 10 can be inhibited from having excessively protruding appearance, so that outer appearance of the first sidewall portion 3A can be further improved. Furthermore, since the difference (H1−H2) is 5.0 mm or less, the side block 10 maintains its stiffness, and durability thereof can be enhanced. From the viewpoint of inhibiting the side block 10 from having excessively protruding appearance while further reducing portions at which bareness occurs, the difference (H1−H2) is more preferably 4.0 mm or less and even more preferably 3.0 mm or less in combination with any of the lower limit values. As one example, the difference (H1−H2) is more preferably 1.0 to 4.0 mm and even more preferably 1.5 to 3.0 mm.

As shown in FIG. 1, for example, the tire 1 includes a first bead portion 4A, a second sidewall portion 3B, and a second bead portion 4B. The first bead portion 4A is connected to the first sidewall portion 3A. The second sidewall portion 3B is connected to the tread portion 2 at the side opposite to the first sidewall portion 3A in the tire axial direction. The second bead portion 4B is connected to the second sidewall portion 3B. In the present embodiment, the second sidewall portion 3B has the same shape as the first sidewall portion 3A. In the present embodiment, the side block 10 is disposed at the second sidewall portion 3B. The first bead portion 4A and the second bead portion 4B have the same shape. Therefore, in the description herein, description for the second sidewall portion 3B and the second bead portion 4B is omitted. The second sidewall portion 3B may have a different shape from the first sidewall portion 3A.

The first sidewall portion 3A or the first bead portion 4A has a mark portion K which is distant from the side block 10 in the tire-radially inward direction. Thus, in the present embodiment, the tire 1 has the mark portion K and the side block 10 distant from each other in the tire radial direction. Thus, the basic aesthetic shape (design) provided by the side block 10 is maintained to be highly good. The mark portion K is a recess-like portion or a protrusion-like portion disposed at the outer surface 3s of the first sidewall portion 3A or an outer surface 4s of the first bead portion 4A, includes a character, a figure, a symbol, etc., and represents information such as a tire size and production year and week.

The belt layer 7 is formed by stacking a plurality of belt plies in the tire radial direction. In the present embodiment, the plurality of belt plies are formed of two belt plies which are an outer belt ply 7A disposed on the outermost side in the tire radial direction, and an inner belt ply 7B disposed inward of the outer belt ply 7A in the tire radial direction. The plurality of belt plies are not limited to two belt plies.

Each of the outer belt ply 7A and the inner belt ply 7B includes a plurality of belt cords aligned at an angle of 15 to 45° relative to the tire circumferential direction, and topping rubber covering the belt cords (not shown). For the belt cords, for example, steel cords, or organic fiber cords formed of aramid, rayon, etc., are adopted.

For example, the inner belt ply 7B has a length L1 greater than the outer belt ply 7A in the tire axial direction. Both outer ends 7e of the inner belt ply 7B in the tire axial direction are disposed inward of tread ends Te in the tire axial direction.

In the case of a pneumatic tire, the tread end Te is a position at which the tire 1 in a standardized load-applied state comes into contact with a plane at the outermost side of the tire 1 in the tire axial direction. The standardized load-applied state represents a state where a standardized load is applied to the tire 1 in the standardized state, and the tire 1 is brought into contact with the plane at a camber angle of 0°. The “standardized load” refers to a load that is defined, in a standard system including a standard on which the tire 1 is based, by the standard for each tire, and is “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard.

The tire 1 further includes a carcass 6 extending toroidally between the first bead portion 4A and the second bead portion 4B, the tread rubber 2G disposed at the tread portion 2, and the sidewall rubber 3G disposed at the first sidewall portion 3A.

For example, the carcass 6 is formed of an outer carcass ply 6A and an inner carcass ply 6B disposed inward of the outer carcass ply 6A in the tire. For example, the outer carcass ply 6A is adjacent to the inner belt ply 7B on the inner side in the tire radial direction. For example, each of the carcass plies 6A, 6B includes a body portion 6a extending between the first bead portion 4A and the second bead portion 4B, and turned-up portions 6b continuous with the body portion 6a. For example, the carcass 6 may be formed of one carcass ply.

Each of the carcass plies 6A, 6B includes a plurality of carcass cords, and topping rubber covering the carcass cords (not shown). For the carcass cords, for example, organic fiber cords formed of aramid, rayon, etc., are adopted. For example, the carcass cords are preferably aligned at an angle of 70 to 90° relative to the tire circumferential direction.

For example, the tread rubber 2G forms a ground contact surface 2s of the tread portion 2, and extends outward of the tread ends Te in the tire axial direction. For example, the sidewall rubber 3G forms the side block 10. A boundary surface Bs (shown in FIG. 3) between the tread rubber 2G and the sidewall rubber 3G extends outward in the tire axial direction from the outer end of the belt layer 7 in the tire axial direction, e.g. the outer end 7e of the inner belt ply 7B, and is connected to the outer surface 3s of a sidewall portion 3 in the region A1. The boundary surface Bs is not limited to such a boundary surface extending in the tire axial direction. The tread rubber 2G and the sidewall rubber 3G are formed of known rubber materials.

Shoulder lateral grooves 8 extending from a tire equator C side beyond the tread end Te are formed in the tread portion 2. The shoulder lateral grooves 8 are aligned in the tire circumferential direction (not shown). For example, the shoulder lateral groove 8 includes a groove bottom 8s extending inward and outward across the tread end Te in the tire axial direction. In the present embodiment, the groove bottom 8s extends almost parallel to the ground contact surface 2s.

As shown in FIG. 3, in the description herein, the sidewall reference surface 3k is an outer surface of the first sidewall portion 3A excluding recesses and protrusions such as spews, bulges, dents, and the mark portion K. For example, the sidewall reference surface 3k may be formed so as to be smoothly connected from the tread end Te of the tread portion 2. For example, the sidewall reference surface 3k may be formed so as to be smoothly connected to the groove bottom 8s of the shoulder lateral groove 8. For example, the sidewall reference surface 3k is formed as an arc that protrudes outward in the tire axial direction.

In the description herein, the imaginary extension line 7i is specified by the inner surface of the belt ply disposed on the innermost side in the tire radial direction. In the present embodiment, the imaginary extension line 7i is specified by an inner surface 7u of the inner belt ply 7B. The imaginary extension line 7i is formed as an arc having the same curvature radius as the inner surface 7u of the inner belt ply 7B. In a case where the inner surface 7u is not formed as an arc having a constant curvature radius between both the outer ends 7e of the inner belt ply 7B, the inner surface 7u is specified by connecting between a point 7c (shown in FIG. 1) on the tire equator C and both the outer ends 7e in the tire axial direction by an arc Sa having a constant curvature radius.

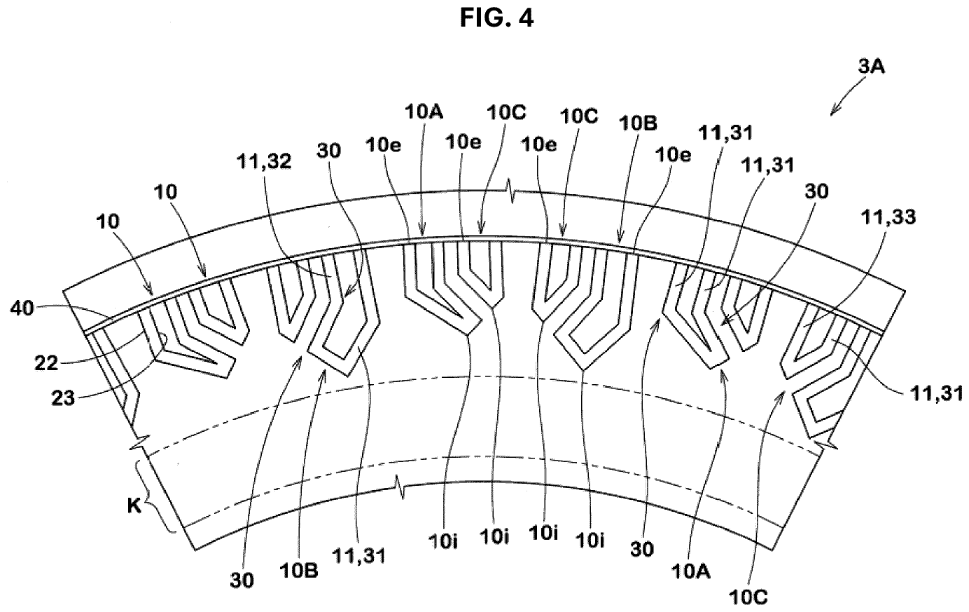

FIG. 4 is a front view of the first sidewall portion 3A. As shown in FIG. 4, in the present embodiment, the first sidewall portion 3A has a plurality of the side blocks 10. In the present embodiment, the side blocks 10 include first side blocks 10A, second side blocks 10B, and third side blocks 10C. In the present embodiment, the outer ends 10e of the first side block 10A, the second side block 10B, and the third side block 10C are disposed at the same position in the tire radial direction. For example, the inner ends 10i of the first side block 10A, the second side block 10B, and the third side block 10C are disposed at different positions in the tire radial direction. The side blocks 10 having such a configuration allow the first sidewall portion 3A to have variation in visual appearance and have improved outer appearance.

For example, in the first side block 10A, each of the pair of first portions 11 is formed of a first bending portion 31 having one bend portion 30. For example, in the second side block 10B, one of the pair of first portions 11 is formed of the first bending portion 31, and the other of the pair of first portions 11 is formed of a second bending portion 32 having two bend portions 30. For example, in the third side block 10C, one of the pair of first portions 11 is formed of the first bending portion 31, and the other of the pair of first portions 11 is formed of a linear portion 33 that linearly extends. In the present embodiment, the linear portion 33 extends parallel to the tire radial direction.

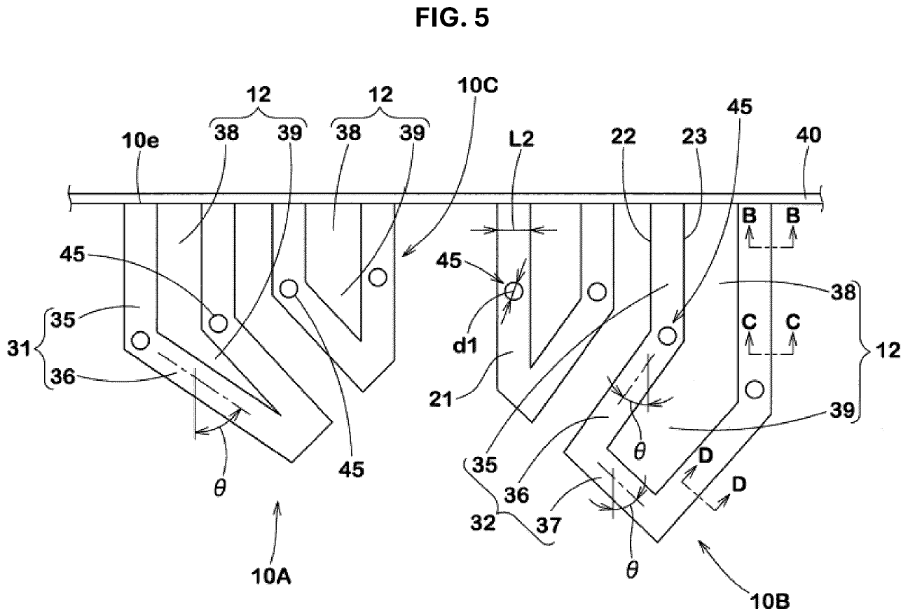

FIG. 5 is an enlarged schematic diagram of FIG. 4. As shown in FIG. 5, the first bending portion 31 includes a radial direction portion 35 extending in the tire radial direction, and a first inclined portion 36 inclined at an angle greater than that of the radial direction portion 35 relative to the tire radial direction. The second bending portion 32 includes the radial direction portion 35, the first inclined portion 36, and a second inclined portion 37 inclined in the opposite direction to the inclination direction of the first inclined portion 36 relative to the tire radial direction. In the present embodiment, the radial direction portion 35 extends parallel to the tire radial direction. The first inclined portion 36 is connected to the radial direction portion 35 on the inner side in the tire radial direction. The second inclined portion 37 is connected to the first inclined portion 36 on the inner side in the tire radial direction. For example, the first inclined portion 36 and the second inclined portion 37 are inclined at an angle θ of 30° or more relative to the tire radial direction. The shape of the side block 10 is not limited to such a shape.

In the present embodiment, the second portion 12 of each side block 10 includes an equal length portion 38 and a tapered portion 39. The equal length portion 38 is formed so as to extend inward from the outer end 10e of the side block 10 in the tire radial direction with the same length in the tire circumferential direction. The tapered portion 39 is disposed inward of the equal length portion 38 in the tire radial direction and is formed so as to have a length, in the tire circumferential direction, which is reduced toward the inner end 10i of the side block 10. The shape of the second portion 12 is not limited to such a shape. In FIG. 4 and FIG. 5, for the sake of convenience, each of the outer wall surface 22 and the inner wall surface 23 is indicated by one line.

As shown in FIG. 2B, for example, the outer wall surface 22 is inclined outward in the tire axial direction toward the inner wall surface 23. For example, the inner wall surface 23 is inclined outward in the tire axial direction toward the outer wall surface 22. The outer wall surface 22 or the inner wall surface 23 having such a configuration allows air to more smoothly flow in the vulcanization mold in contact with the outer wall surface 22 and the inner wall surface 23 during tire vulcanization, and outer appearance of the first sidewall portion 3A is thus improved.

In order to effectively exhibit the above-described effect, an angle α1 between the inner wall surface 23 and the normal line n1 normal to the second top surface 28 is preferably 15° or more. From the viewpoint of achieving both the effect of inhibiting occurrence of bareness and the effect of allowing the side block 10 to have good design, the angle α1 is preferably 20° or more, and preferably 60° or less and more preferably 45° or less. In the present embodiment, the angle α1 is constant between the inner side and the outer side of the second portion 12 in the tire radial direction.

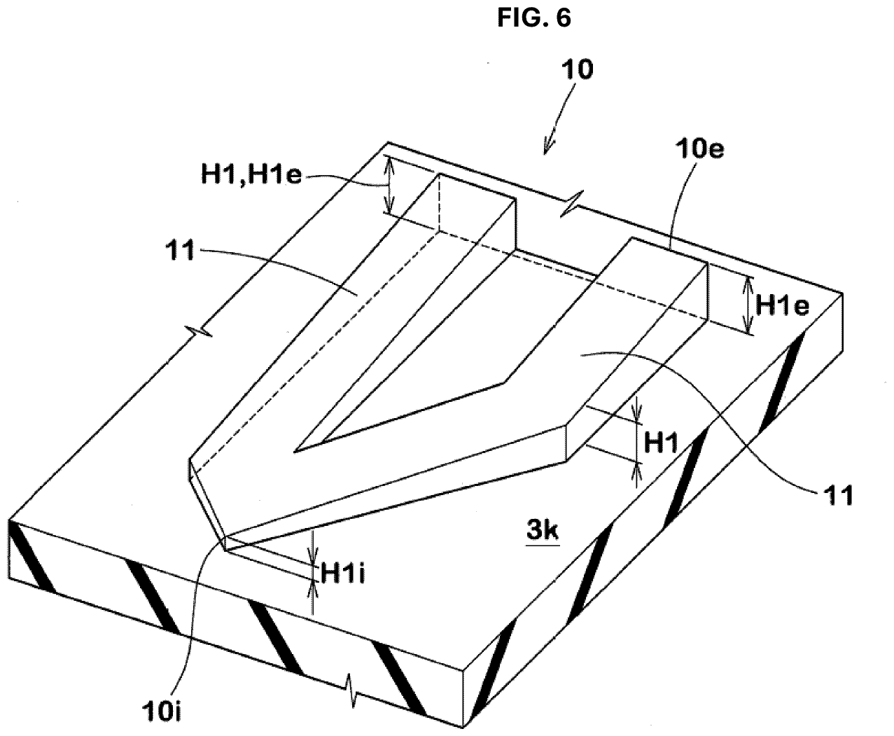

FIG. 6 is a perspective cross-sectional view of the side block 10. As shown in FIG. 6, for example, each of the pair of first portions 11 has the first protrusion height H1 that is continuously increased outward in the tire radial direction. The first portion 11 having such a configuration allows air to easily flow toward the outer end 10e of the side block 10 during tire vulcanization. Thus, air discharge efficiency is enhanced. A first protrusion height H1i at the inner end 10i of the side block 10 is, for example, preferably 1 mm or more and more preferably 1.5 mm or more, and is preferably 5 mm or less and more preferably 3 mm or less. A difference (H1e−H1i) between the first protrusion height H1i at the inner end 10i of the side block 10 and a first protrusion height H1e at the outer end 10e of the side block 10 is preferably 0.5 mm or more. In the present embodiment, in all of the side blocks 10, the first protrusion height H1 is continuously increased outward in the tire radial direction.

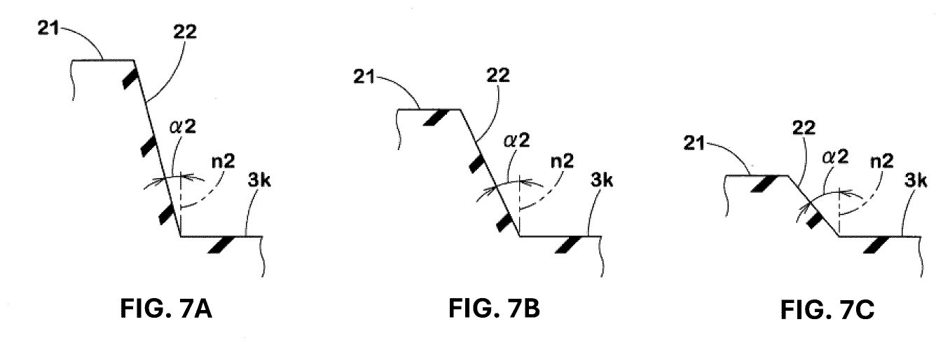

FIG. 7A is a cross-sectional view taken along a line B-B in FIG. 5, FIG. 7B is a cross-sectional view taken along a line C-C in FIG. 5, and FIG. 7C is a cross-sectional view taken along a line D-D in FIG. 5. FIG. 7B shows a cross-section of a portion disposed inward of a portion in FIG. 7A in the tire radial direction. FIG. 7C shows a cross-section of a portion disposed inward of the portion in FIG. 7B in the tire radial direction. FIGS. 7A to 7C is a cross-sectional view of the first portion 11. As shown in FIGS. 7A to 7C, an angle α2 between the outer wall surface 22 and the normal line n2 normal to the sidewall reference surface 3k is increased inward in the tire radial direction. The outer wall surface 22 having such a configuration allows air to more easily flow toward the outer end 10e of the side block 10 during tire vulcanization. Thus, the air discharge efficiency is enhanced. The angle α2 may continuously have the same value between an inner end 35i in the tire radial direction and an outer end 35e in the tire radial direction in the radial direction portion 35.

As shown in FIG. 3 to FIG. 5, the first sidewall portion 3A includes a circumferential protruding portion 40 protruding from the sidewall reference surface 3k over a third protrusion height H3, and extending in the tire circumferential direction. The circumferential protruding portion 40 is connected to the outer end 10e of the side block 10. Thus, air accumulated in the vulcanization mold for forming the side block 10 can also flow into the vulcanization mold for forming the circumferential protruding portion 40 during tire vulcanization, so that portions at which bareness occurs can be further reduced. In the present embodiment, the circumferential protruding portion 40 continuously extends in the tire circumferential direction without interruption. The circumferential protruding portion 40 is not limited to such a configuration. For example, a plurality of the circumferential protruding portions 40 may be disposed intermittently at equal pitches in the tire circumferential direction (not shown). The circumferential protruding portion 40 is disposed in the region A1 in the present embodiment.

The third protrusion height H3 of the circumferential protruding portion 40 having such a configuration is preferably 1 mm or more and more preferably 2 mm or more, and is preferably 5 mm or less and more preferably 4 mm or less. In order to improve outer appearance of the first sidewall portion 3A, the third protrusion height H3 is preferably less than the first protrusion height H1. Such a circumferential protruding portion 40 having the third protrusion height H3 can exhibit an effect of accumulating air in the circumferential protruding portion 40 and efficiently discharging the air without degrading outer appearance.

As shown in FIG. 5, in the present embodiment, the first top surface 21 has at least one spew 45. The spew 45 refers to rubber that has flowed into the air discharge hole (not shown) formed in the vulcanization mold and has been plasticized during tire vulcanization, and is formed as a thin rubber piece having a whisker-like shape. The air discharge hole has a function of discharging air in a mold to the outside of the mold during tire vulcanization. In other words, in the present embodiment, air in the vulcanization mold is discharged through the air discharge hole formed in the vulcanization mold for forming the first top surface 21 during tire vulcanization of the tire 1. As described above, air in the components of the tire 1 and a lot of air between the components are accumulated into the vulcanization mold for forming the first top surface 21. Therefore, the tire 1 of the present embodiment allows outer appearance of the first sidewall portion 3A to be highly improved. The spews 45 include spew marks and the like formed by removing the spews 45. For the sake of convenience, in FIGS. 2 to 4 and FIG. 6, spews are omitted.

An outer diameter d1 of the spew 45 is preferably two-thirds or more of a length L2 of the first top surface 21. The air discharge hole that forms the spew 45 having such a configuration allows air to be more smoothly discharged during tire vulcanization. In order to maintain outer appearance of the first sidewall portion 3A, the outer diameter d1 of the spew 45 is preferably less than one times the length L2 of the first top surface 21. In the description herein, the length L2 of the first top surface 21 is defined as a length in the direction orthogonal to the longitudinal direction of the first top surface 21.

The spews 45 are preferably disposed at equal pitches over the length of the first top surface 21 in the tire radial direction. However, the present disclosure is not particularly limited thereto. In other words, in a case where one spew 45 is disposed at the first top surface 21, the spew 45 is preferably disposed at the center of the first top surface 21 in the tire radial direction. In a case where two spews 45 are disposed at the first top surface 21, the spews 45 are preferably disposed at positions at which the first top surface 21 is equally divided into three portions in the tire radial direction.

In the first sidewall portion 3A, for example, the spew 45 is disposed merely at the first portion 11 of the side block 10, and no spews 45 are preferably disposed at the second portion 12 and the sidewall reference surface 3k. For example, the spew 45 may be disposed at the circumferential protruding portion 40.

Although the particularly preferred embodiment of the present disclosure has been described above in detail, the present disclosure is not limited to the illustrated embodiment, and various modifications can be made to implement the present disclosure.

### Examples

Pneumatic tires having the basic structure shown in FIG. 1 were produced as test tires according to the specifications in Table 1. Each test tire was tested for outer appearance. The specifications common to the test tires and a test method were as follows.
Tire size: 285/70R17

### <Outer Appearance>

A tester visually made sensory evaluation for an outer surface of the first sidewall portion of each test tire mounted to a vehicle. The result was represented by a score between 0 and 100. The less the value of the score was, the more excellent the design of the side block was and the less occurrence of bareness was, and the outer appearance was better.

Table 1 indicates the test results.

TABLE 1

| | Comp. | | | | Comp. | | |
|---|---|---|---|---|---|---|---|
| | Ex. 1 | Ex. 1 | Ex. 2 | Ex. 3 | Ex. 2 | Ex. 4 | Ex. 5 |
| (La + Lb + | 80 | 75 | 70 | 20 | 15 | 70 | 70 |
| Lc)/LA (%) | | | | | | | |
| α1 (°) | 20 | 20 | 20 | 20 | 20 | 5 | 20 |
| H1e (mm) | 5 | 5 | 5 | 5 | 5 | 5 | 3 |
| H1i (mm) | 1.5 | 1.5 | 1.5 | 1.5 | 1.5 | 1.5 | 3 |
| Outer appearance | 70 | 40 | 30 | 50 | 80 | 60 | 55 |
| [The less the | | | | | | | |
| value between 0 | | | | | | | |
| and 100 was, the | | | | | | | |
| better the outer | | | | | | | |
| appearance was.] | | | | | | | |

The test results indicate that the tires of the examples had improved outer appearance as compared with the tires of the comparative examples.

### [Additional Notes]

The present disclosure includes the following aspects.

### [Present Disclosure 1]

A pneumatic tire including:
a tread portion;
a first sidewall portion connected to the tread portion; and
a belt layer embedded in the tread portion, the belt layer extending in a tire axial direction, wherein
at least one side block protruding outward from a sidewall reference surface in the tire axial direction is formed at the first sidewall portion,
the side block includes an outer end in a tire radial direction,
the outer end is disposed in a region extending over 30 mm in the tire radial direction around a point of intersection of an outer surface of the first sidewall portion, and an imaginary extension line obtained by extending the belt layer toward the first sidewall portion, on a tire meridional cross-section,
the side block includes
a pair of first portions protruding from the sidewall reference surface over a first protrusion height and extending in the tire radial direction, and
a second portion protruding from the sidewall reference surface over a second protrusion height less than the first protrusion height, the second portion disposed between the pair of first portions,
the second portion includes a second top surface parallel to the sidewall reference surface,
each of the pair of first portions includes a first top surface parallel to the sidewall reference surface, an outer wall surface connecting between the first top surface and the sidewall reference surface, and an inner wall surface connecting between the first top surface and the second top surface, and
at a block outer position distant from the outer end of the side block toward an inner side in the tire radial direction over 5 mm, and a block inner position distant from an inner end, in the tire radial direction, of the side block toward an outer side in the tire radial direction over 15 mm, a sum of lengths of a pair of the first top surfaces and a length of the second top surface is 20% or more and 75% or less of a length of the side block in a tire circumferential direction on the sidewall reference surface, on a cross-section obtained by cutting the side block in a direction normal to the sidewall reference surface along the tire circumferential direction.

### [Present Disclosure 2]

The pneumatic tire according to Present Disclosure 1, wherein inner ends of the pair of first portions, respectively, in the tire radial direction are connected to each other.

### [Present Disclosure 3]

The pneumatic tire according to Present Disclosure 1 or 2, wherein an angle between the outer wall surface and a line normal to the sidewall reference surface is increased inward in the tire radial direction.

### [Present Disclosure 4]

The pneumatic tire according to any one of Present Disclosures 1 to 3, wherein an angle between the inner wall surface and a line normal to the second top surface is 15° or more.

### [Present Disclosure 5]

The pneumatic tire according to any one of Present Disclosures 1 to 4, wherein the first protrusion height of each of the pair of first portions is continuously increased outward in the tire radial direction.

### [Present Disclosure 6]

The pneumatic tire according to any one of Present disclosures 1 to 5, wherein the pair of the first top surfaces each have at least one spew.

### [Present Disclosure 7]

The pneumatic tire according to Present Disclosure 6, wherein an outer diameter of the spew is two-thirds or more of a length of the first top surface.

### [Present Disclosure 8]

The pneumatic tire according to any one of Present Disclosures 1 to 7, wherein the first sidewall portion includes a circumferential protruding portion protruding from the sidewall reference surface over a third protrusion height, and extending in the tire circumferential direction, and the circumferential protruding portion is connected to the outer end of the side block.

### [Present Disclosure 9]

The pneumatic tire according to Present Disclosure 8, wherein the third protrusion height is 1.0 mm or more.

### [Present Disclosure 10]

The pneumatic tire according to any one of Present Disclosures 1 to 9, wherein a difference between the first protrusion height and the second protrusion height is 0.5 to 5.0 mm.

What is claimed is:

1. A pneumatic tire comprising:
a tread portion;
a first sidewall portion connected to the tread portion; and
a belt layer embedded in the tread portion, the belt layer extending in a tire axial direction, wherein
at least one side block protruding outward from a sidewall reference surface in the tire axial direction is at the first sidewall portion,
the side block includes an outer end in a tire radial direction,
the outer end is in a region extending over 30 mm in the tire radial direction around a point of intersection of an outer surface of the first sidewall portion, and an imaginary extension line obtained by extending the belt layer toward the first sidewall portion, on a tire meridional cross-section,
the side block includes
a pair of first portions protruding from the sidewall reference surface over a first protrusion height and extending in the tire radial direction, and
a second portion protruding from the sidewall reference surface over a second protrusion height less than the first protrusion height, the second portion being between the pair of first portions,
the second portion includes a second top surface parallel to the sidewall reference surface,
each of the pair of first portions includes a first top surface parallel to the sidewall reference surface, an outer wall surface connecting between the first top surface and the sidewall reference surface, and an inner wall surface connecting between the first top surface and the second top surface, and
at a block outer position distant from the outer end of the side block toward an inner side in the tire radial direction over 5 mm, and a block inner position distant from an inner end, in the tire radial direction, of the side block toward an outer side in the tire radial direction over 15 mm, a sum of lengths of a pair of the first top surfaces and a length of the second top surface is from 20% to 75% of a length of the side block in a tire circumferential direction on the sidewall reference surface, on a cross-section obtained by cutting the side block in a direction normal to the sidewall reference surface along the tire circumferential direction.

2. The pneumatic tire according to claim 1, wherein
inner ends of the pair of first portions, respectively, in the tire radial direction are connected to each other.

3. The pneumatic tire according to claim 2, wherein
an angle between the outer wall surface and a line normal to the sidewall reference surface is increased inward in the tire radial direction.

4. The pneumatic tire according to claim 1, wherein
an angle between the inner wall surface and a line normal to the second top surface is 15° or more.

5. The pneumatic tire according to claim 1, wherein
the first protrusion height of each of the pair of first portions is continuously increased outward in the tire radial direction.

6. The pneumatic tire according to claim 1, wherein
the pair of the first top surfaces each have at least one spew.

7. The pneumatic tire according to claim 6, wherein
an outer diameter of the spew is two-thirds or more of a length of the first top surface.

8. The pneumatic tire according to claim 1, wherein
the first sidewall portion includes a circumferential protruding portion protruding from the sidewall reference surface over a third protrusion height, and extending in the tire circumferential direction, and
the circumferential protruding portion is connected to the outer end of the side block.

9. The pneumatic tire according to claim 8, wherein
the third protrusion height is 1.0 mm or more.

10. The pneumatic tire according to claim 1, wherein
a difference between the first protrusion height and the second protrusion height is 0.5 to 5.0 mm.

11. The pneumatic tire according to claim 1, wherein
the side block further includes an inner end which is opposite to the outer end in the tire radial direction, and
the side block is tapered from the inner end to the outer end such that the first protrusion height at the inner end of the side block is less than the first protrusion height at the outer end of the side block.
